(19) United States
(12) Patent Application Publication
(10) Pub. No.: US 2024/0215541 A1
(43) Pub. Date: Jul. 4, 2024

(54) SYSTEM FOR CONTROLLING A SOOTHING ACCESSORY FOR AN ANIMAL AND ACCESSORY AND METHOD FOR SAME

(71) Applicant: AB7 SANTE, DEYME (FR)

(72) Inventors: Christophe CALMET; David NGUYEN, TOULOUSE (FR); Arnaud VILBERT, BAZIEGE (FR)

(21) Appl. No.: 18/571,060

(22) PCT Filed: Jun. 14, 2022
(86) PCT No.: PCT/FR2022/000056

§ 371 Date: Dec. 15, 2023

(30) Foreign Application Priority Data
Jun. 16, 2021 (FR) FR2106393

(51) Int. Cl. A01K 15/02; A01K 27/00; A01K 29/00

(52) U.S. Cl. CPC A01K 15/022; A01K 29/005; A01K 27/001

(57) ABSTRACT

The present invention relates to a system for controlling an accessory for an animal comprising a device spraying an active agent comprising a spray mechanism and at least one sensor acquiring measurements relating to the animal or its environment, the control system comprising: —a receiving unit which receives initial data acquired by the at least one sensor, —a determination unit which determines a control law for the spray mechanism, according to the received data, by selecting an operating mode (MP1, MP2, MP3, MS) from several modes (MP1, MP2, MP3, MS), each corresponding to a control law respectively encoding a number of activations of the spray mechanism for a predetermined duration and a duration for each activation, and —a sending unit capable of sending the determined control law to the spray mechanism.

The present invention relates to a system for controlling an accessory for animals. It also relates to an accessory comprising such a control system and a method for controlling an accessory.

Like most animals, dogs feel stress which is a natural reaction, in particular when faced with a danger or an unknown situation. The stress of the dog can drive it to adopt a specific behavior, and help it face a threat.

However, when the stress is too high, it can rapidly induce a behavior disorder, such as loss of cleanliness, inappropriate barking, or property destruction.

It is therefore desirable to be able to soothe a dog by channeling its anxiety or calming it.

In practice, a dog shows its stress through various signs, including hypersalivation, trembling, pupil dilation or digestive disorders. These symptoms are difficult to identify, on the one hand because the stress can be normal, and on the other hand because these symptoms are relatively common and can manifest when nobody is present (owner has left for work).

Thus, it is difficult for a dog owner to realize that their dog needs to be soothed.

Similar problems exist for other domestic animals.

There is therefore a need for a system for controlling an animal accessory that makes it possible to better detect the state of an animal and analyze its behavior and to determine how to best soothe the animal in real time.

To this end, the description describes a system for controlling an animal accessory,
the accessory comprising:
a rechargeable device for spraying an active ingredient comprising an active ingredient reservoir and a nebulization body with a controllable spray mechanism,
a set of at least one sensor, the set of at least one sensor being able to acquire measurements relating to the animal carrying the accessory or to its environment, said control system comprising:
a receiving unit able to receive data, said data received by the receiving unit comprising first data acquired by the set of at least one sensor,
a determination unit able to determine a control law of the spray mechanism as a function of the received data, to obtain a determined control law, the determination unit being able to determine the control law by selecting an operating mode from a plurality of operating modes, each operating mode being a control law encoding for a number of activations of the spray mechanism for a predetermined duration and a duration for each activation, the number of activations and the duration of each activation being specific to each operating mode, and
a sending unit able to send the determined control law to the spray mechanism.

Compared to document WO 2020/074796 A1, which describes an automated device for the targeted spraying of active material, such a control system is an autonomous and adaptive system.

Indeed, the control system makes it possible to adjust the operating modes of the spray mechanism, and therefore the dosage, to the behavior of the animal using at least one sensor.

The control system is thus capable of causing the switching of the operating modes of the spray mechanism as a function of measurements carried out on the animal in order to ensure good adaptation of the dosage of the animal.

In other words, the control system is capable of determining how to best soothe the animal in real time and control the spraying device to apply the treatment.

Compared to document US 2020/108408 A1 which describes a device for dispersing a digitally controlled chemical agent, the control system is adaptive in the sense that it proposes suitable operating modes in terms of duration and periodicity and not a choice between an application of chemical agent or no application of that chemical agent.

The control system is furthermore a system for obtaining both long-term treatment and short-term treatment.

According to particular embodiments, the control system has one or more of the following features, considered alone or according to all technically possible combinations:
the set of sensors comprises a motion measurement unit comprising at least one of an accelerometer or a gyroscope, the first data comprising a property of a motion of the animal, the property being selected from the amplitude of the motion of the animal, the frequency of the motion of the animal, the distance made by the animal, the direction of the motion of the animal or the duration of the motion of the animal.
the set of sensors comprises a microphone, the first data comprising a property of a sound recorded by the microphone, the property being chosen from the sound intensity of the sound, the sound frequency of the sound or the duration of the sound.
the operating modes comprise main operating modes, for example greater than or equal to 3, and at least one secondary operating mode, a main operating mode being an operating mode for which the predetermined duration is greater than 100 times the duration of activation and a secondary operating mode being an operating mode for which the predetermined duration is less than 5 times the duration of an activation.
the determination unit is able to determine whether a criterion relating to the first data is satisfied and is able to select a secondary operating mode when said criterion is satisfied.
the determination unit is able to count the number of selections of a secondary operating mode during a counting duration, the determination unit switching from a main operating mode to another main operating mode as a function of the number of selections counted.
each predetermined duration associated with a main operating mode and the counting duration are identical.
the data received by the receiving unit comprises second data, the second data being information related to the animal, the determination unit being able to initialize the control law to a selected main operating mode according to the second data.
the data received by the receiving unit comprises an item of third data relating to a manual activation of a button, the determination unit then selecting a secondary operating mode as a function of the item of third data. The description also relates to an animal accessory comprising:
a rechargeable device for spraying an active ingredient comprising an active ingredient reservoir and a nebulization body with a controllable spray mechanism,
a set of at least one sensor, the set of at least one sensor being able to acquire measurements relating to the animal carrying the accessory or to its environment, and
a control system as described above.

The description also relates to a method for controlling an animal accessory comprising:
a rechargeable device for spraying an active ingredient comprising an active ingredient reservoir and a nebulization body with a controllable spray mechanism,
a set of at least one sensor, the set of at least one sensor being able to acquire measurements relating to the animal carrying the accessory or to its environment, the control method being performed by a control system and comprising the steps of:
receiving the data, the received data comprising first data, the first data being data acquired by the set of at least one sensor,
determining a control law of the spray mechanism as a function of the received data, to obtain a determined control law, the step of determining comprising the selection of an operating mode from a plurality of operating modes, each operating mode being a control law encoding for a number of activations of the spray mechanism for a predetermined duration and a duration for each activation, the number of activations and the duration of each activation being specific to each operating mode, and
sending the determined control law to the spray mechanism.

In the present description, the expression “able to” interchangeably means “suitable for”, “adapted to” or “configured to”.

Features and advantages of the invention will become apparent on reading the following description, given solely by way of non-limiting example, and made with reference to the appended drawings, in which:

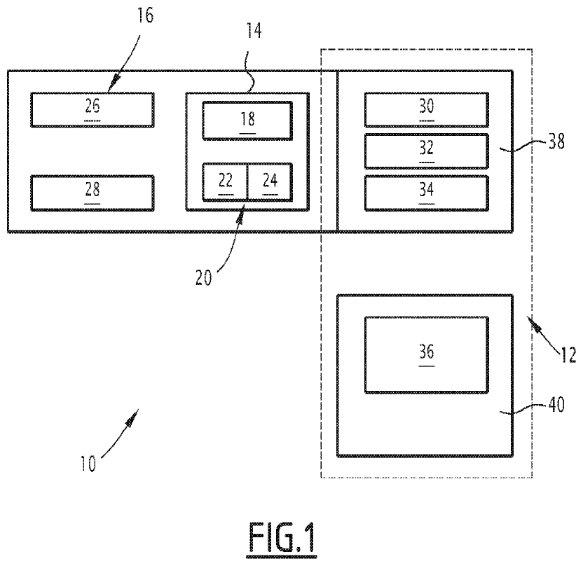

FIG. 1 is a schematic view of an accessory of an animal and of a control system, and

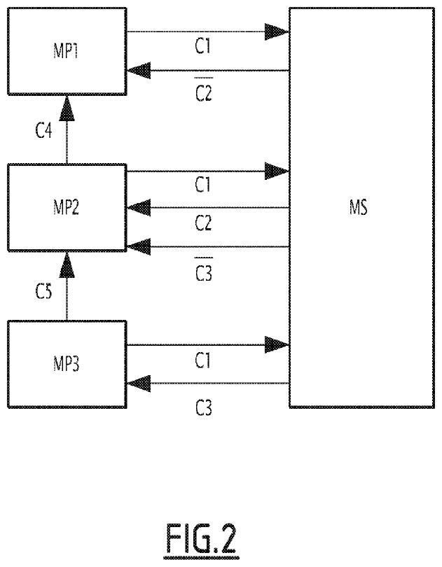

FIG. 2 is a schematic representation of an example of a flowchart of a control method implemented by the control system.

An animal accessory 10 and a control system 12 are shown in FIG. 1.

An accessory 10 is an element intended to be worn by a part of the body of an animal.

In the example described, the accessory 10 is a collar, i.e. an element intended to be worn around the neck of an animal.

Alternatively, a harness, belt, or bracelet can also be considered an accessory.

The animal is a pet, in particular a cat or a dog.

The accessory 10 comprises a spraying device 14 and a set 16 of sensors.

The spraying device 14 is a device for spraying an active ingredient.

A spraying device 14 is able to spray a cloud of droplets of an active ingredient. The sprayed droplets are relatively fine, typically have a size of between 1 micrometer (μm) and 20 μm, preferably between 1 μm and 10 μm.

The spraying device 14 makes it possible to spray the active ingredient in a localized manner on a specific area of the animal, and in particular the vomeronasal organ (more often called Jacobson's organ).

The spraying device 14 can also be used multidirectionally and independently of the movements of the subject. Thus, the spraying device 14 is capable of effectively spraying an active ingredient regardless of the orientation of the spraying device 14 and the movements imposed thereto.

For this, the spraying device 14 comprises an active ingredient reservoir 18 and a nebulization body 20 with a controllable spray mechanism 22.

The active ingredient reservoir 18 may be a fillable and reusable cartridge, or a cartridge that is disposable after use.

According to the example described, the reservoir 18 is included in a swappable cartridge.

This makes it possible to obtain a refillable spraying device 14, that is to say a device that can be filled again after use when the reservoir 18 is empty.

Alternatively, the reservoir 18 comprises a filling valve directly integrated on the surface of the reservoir 18.

The nebulization body 20 is able to nebulize the liquid active ingredient into a cloud of droplets.

For this, the nebulization body 20 comprises multiple elements, among which the spray mechanism 22.

The spray mechanism 22 is controllable.

This means that a control law enables the activation of the spray mechanism 22. The control law thus makes it possible to control and/or trigger the remote spraying of the active ingredient.

According to the example described, when the control law triggers the spraying of an active ingredient by the spray mechanism 22, the latter delivers an amount of liquid which depends only on the duration of the spraying, the flow rate being fixed by the spray mechanism 22. The volume of ejected liquid can thus be between X and X [Please complete].

A piezoelectric spray mechanism is an example of a spray mechanism 22 that can thus be controlled.

A piezoelectric spray mechanism is a mechanism comprising a piezoelectric disc in contact with the active ingredient, said disc vibrating at a frequency allowing nebulization.

Advantageously, the nebulization body 20 is equipped with an orientation system 24 of the piezoelectric spray mechanism 22 to allow the active ingredient to be properly sprayed in the desired area.

The active ingredient is a substance formulated within a liquid composition in order to be able to come into contact with the piezoelectric device, the vibration frequency of which will allow the liquid to be nebulized and the substance to be dispersed in the form of a cloud or mist.

The liquid composition containing the active ingredient is of the aqueous, alcoholic, hydroalcoholic, or oily type or in the form of an emulsion, the nature of which will be adapted to the active ingredient.

According to a particular embodiment, the composition is exclusively composed of the pure active ingredient, without solvent.

According to another embodiment, the active ingredient is diluted within the composition by means of at least one solvent. Examples of usable solvents comprise, in particular, aromatic or aliphatic hydrocarbons, halogenated hydrocarbons, aromatic or aliphatic alcohols, esters, ethers and ketones, or water.

More preferably, the solvents that can be used are triglycerides, such as vegetable or animal oils, or alcoholic solvents, such as ethanol.

Formulation adjuvants can also be added such as, for example, stabilizers, surfactants, synergists, antimicrobial agents.

The active ingredient represents between 0.01% and 100% of the liquid composition, preferably between 0.1% and 50% and even more preferentially between 0.5% and 30%.

Here, the active ingredient is an anti-stress or a soothing agent.

By way of example, the antistress or the soothing agent is a vegetable oil such as hemp oil, or essential oil such as essential oil of valerian, nepeta caticara, pine, mandarin, bigabradier, vervein, ravinatra, chamomile, lavender, marjowool, ylang-ylang, rosemary, eucalyptus, mint, or a cannabinoid oil free of tetrahydrocannabinol (THC), of the type of THC-free cannabidiol (CBD) oil, or mixtures thereof. The antistress or the soothing agent may also be a compound or mixture of a soothing pheromone type, such as, but not exclusively, cat- or dog-soothing pheromones.

According to the example described in FIG. 1, the set 16 of sensors comprises two sensors which are a motion measurement unit 26 and a microphone 28.

A motion measurement unit 26 is a unit capable of acquiring at least one property of the motion of the animal.

The motion unit 26 makes it possible to obtain a property of said motion to analyze the behavior of the animal, typically anxious behavior.

By way of illustration, the motion measurement unit 26 here comprises an accelerometer and a gyroscope, but could comprise only one of the two or comprise other sensors making it possible to record other parameters related to the movements or behavior of the animal.

Indeed, the motion measurement unit 26 is able to acquire a property chosen from the amplitude of the motion of the animal, the frequency of the motion of the animal, the distance traveled by the animal, the direction of the motion of the animal, or the duration of the motion of the animal.

A microphone is a sound sensor. Also, in the example described, the microphone 28 is able to measure a property relating to its environment, the property being chosen from the sound intensity of the sound, the sound frequency of the sound or the duration of the sound.

The control system 12 is able to control the accessory 10 and in particular the spray mechanism 22.

The control system 12 is part of the accessory 10. In this sense, the control system 12 is a control system 12 for an accessory.

The control system 12 comprises a reception unit 30, a determination unit 32, a sending unit 34 and a human-machine interface 36.

The receiving unit 30 is able to receive data.

According to the example described, the data received by the receiving unit 30 comprises the data from the set 16 of sensors.

The determination unit 32 is able to determine a control law of the spray mechanism 22 as a function of the data received.

The determination unit 32 thus obtains a determined control law.

The sending unit 34 is able to send the determined control law to the spray mechanism 22.

The human-machine interface 36 allows a user, in particular the master of the animal, to interact with the control system 12.

The human-machine interface 36 is, for example, a touch screen enabling both the user to enter information or commands and to provide information to the user. Such a human-machine interface 36 thus combines the functions of an input device and an output device.

In one variant, a separate input device and output device are used.

By way of illustration, the input device is a keyboard. In one variant, the input device is a pointing peripheral (such as a mouse, a touchpad and a graphics tablet), a voice recognition device, an oculometer, or a haptic device.

Similarly, the output device may be a display screen enabling a visual presentation of the output. In other embodiments, the output device is a printer, an augmented and/or virtual display unit, a loudspeaker or another sound-generating device to present the output in sound form, a unit producing vibrations and/or odors or a unit adapted to produce an electrical signal.

In the case of FIG. 1, the control system 12 is implemented physically in two parts, the first part grouping together the receiving unit 30, the determination unit 32 and the sending unit 34 and the second part corresponding to the human-machine interface 36

Here, the first part is an electronic circuit embedded in the accessory 10 while the second part is a terminal 40.

In the embodiment described, the first part is a computer 38.

The computer 38 is an electronic circuit designed to manipulate and/or transform data represented by electronic or physical quantities into registers of the computer 38 and/or memories into other similar data corresponding to physical data in register memories or other types of display devices, transmission devices or storage devices.

As specific examples, the computer 38 comprises a single-core or multi-core processor (such as a central processing unit (CPU), a graphics processing unit (GPU), a microcontroller and a digital signal processor (DSP), a programmable logic circuit (such as an application-specific integrated circuit (ASIC), a programmable gate array (ASIC), in-situ (FPGA), a programmable logic device (PLD) and programmable logic arrays (PLA), a state machine, a logic gate and discrete hardware components.

The computer 38 is electrically connected to each of the sensors of the set 16 of sensors.

In one variant, it is conceivable to allow communication with the sensors by bus or an input/output interface.

In the example described, the terminal 40 is a smartphone.

The smartphone is able to implement an application in communication with the computer 38 via a communication network.

An application is a set of program instructions generally downloaded from an external source.

For example, the form of program instructions is a form of source code, a computer-executable form or any intermediate form between a source code and a computer-executable form, such as the form resulting from the conversion of the source code via an interpreter, an assembler, a compiler, a linker or a localizer.

Alternatively, the program instructions are a microcode, firmware instructions, state definition data, integrated circuit configuration data (for example, VHDL) or object code.

Other physical implementations are possible as variants.

For example, the computer 38 can be remote from the accessory 10. In such a case, the computer 38 receives the data from the set 16 of sensors either by a wired system or using antennas.

It is also possible to consider that the computer 38 and the human machine interface 36 are made in the form of a single system such as a remote control.

It could also be envisaged that the computer 38 is part of the computer of the terminal 40. In such a case, by way of example, an application or any other computer program could perform the actions of all of the units.

Such an embodiment corresponds to an execution entirely or partially performed on a single computer, but it is also possible that the execution of the different functions is performed by a system distributed between several computers (in particular via the use of cloud computing).

The operation of the control system 12 is now described with reference to FIG. 2 which shows a flowchart of an example operation of a method for controlling the accessory 10.

In the example described, the control system 12 is able to control the spraying device 14 according to several operating modes.

By definition, an operating mode is a control law encoding for a number of activations of the spray mechanism 22 for a predetermined duration and a duration for each activation.

The number of activations is the number of times the spray mechanism 22 is triggered during the predetermined duration.

The activation duration is the time interval elapsed between the start of activation of the spray mechanism 22 and the end of the activation of the spray mechanism 22.

These various parameters correspond to a dosage of administration of the active ingredient to the animal.

The number of activations and the duration of each activation are specific to each operating mode.

In other words, each operating mode corresponds to a specific dosage.

The operating modes comprise main operating modes MP1, MP2 and MP3 and at least one secondary operating mode MS.

It is recalled here that the example described is in no way limiting and as well as the number of main operating modes, just like the number of secondary operating modes, can be any number.

A main operating mode MP1, MP2 or MP3 is an operating mode for which the predetermined duration is much greater than the duration of an activation, for example between 10 times and 200 times the duration of an activation, preferably greater than 100 times the duration of an activation.

A main operating mode MP1, MP2 or MP3 therefore corresponds to background treatment.

For example, the predetermined duration is on the order of a day while the activation duration is less than 1 minute.

A secondary operating mode MS is an operating mode for which the predetermined duration is less than 5 times the duration of an activation.

In the example described, the predetermined duration is equal to the duration of an activation, the two durations thus being on the order of no more than 1 minute.

A secondary operating mode MS thus corresponds to one-time treatment.

According to the example described, without this being limiting, the main operating modes MP1, MP2 and MP3 are three in number.

The first main operating mode MP1 corresponds to a number of activations equal to 1, the predetermined duration is one day and the activation duration is 20 seconds.

The first main operating mode MP1 thus corresponds to a treatment suitable for an animal that is not very stressed (low treatment).

The second main operating mode MP2 corresponds to a number of activations equal to 2, the predetermined duration is one day and the activation duration is 30 seconds.

The second main operating mode MP2 thus corresponds to a treatment suitable for an animal that is moderately stressed (medium treatment).

The third main operating mode MP3 corresponds to a number of activations equal to 3, the predetermined duration is one day and the activation duration is 45 seconds.

The third main operating mode MP3 thus corresponds to a treatment suitable for an animal that is heavily stressed (high treatment).

Several observations can be made regarding these different values for the activation number, the predetermined duration and the activation duration.

Thus, each main operating mode MP1, MP2 and MP3 corresponds to a specific number of activations, the difference in the number of neighboring activations is greater than or equal to 1, here equal to 1.

Each main operating mode MP1, MP2 and MP3 corresponds to a specific activation duration, the ratio between two neighboring activation durations being between 130% and 170%.

Of course, what has just been explained is not limiting.

For example, the activation durations of each of the main operating modes MP1, MP2 and MP3 could be different.

Typically, the activation duration of the first main operating mode MP1 is between 1 s and 20 s, the activation duration of the second main operating mode MP2 is between 10 s and 40 s and the activation duration of the second main operating mode MP2 is between 15 s and 1 minute; the number of activations is between 1 and 5 and the predetermined duration is between one day and three days.

The number of secondary operating mode MS is equal to 1 in the case of FIG. 2.

According to the example described, the secondary operating mode MS corresponds to an activation number equal to 1 and an activation duration of 40 s.

In this particular case, the activation duration and the predetermined duration are one and the same.

As indicated above, it is the determination unit 32 that determines which operating mode is appropriate.

To do this, the determination unit 32 can be seen as a set of two subunits, a first subunit determining a number of activations of the spray mechanism for a predetermined duration and a second subunit determining a duration for each activation.

Each of these two subunits uses the values given by the set 16 to determine the value of the quantity that the considered subunit calculates.

According to the example described, the determination unit 32 uses criteria to switch between the various operating modes.

The switching criteria depend on the data received.

The determination unit 32 determines whether a criterion relating to the data received is satisfied and selects the operating mode when said criterion is satisfied.

More specifically, the determination unit 32 switches from the current operating mode to another operating mode if the satisfied criterion corresponds to the transition between these two modes.

In this sense, the criteria can be interpreted as switching criteria. The set of switching criteria of FIG. 2 will now be detailed.

It is first possible to switch from a main operating mode MP1, MP2 or MP3 to a secondary operating mode MS.

This corresponds to a first criterion C1.

The first criterion C1 corresponds to determining that the animal undergoes stress related to an event for which it is appropriate to soothe it.

To determine the occurrence of such stress, the data from the sensors is used.

As a particular example, the first criterion C1 is met if at least one sub-criterion is satisfied.

Each of the sub-criteria SC corresponds to a symptom that can be linked to stress or anxiety.

A first sub-criterion SC1 is the presence of uncontrolled slobbering, which can be detected as a function of the amplitude and frequency of the movements of the animal.

A second sub-criterion SC2 is the presence of trembling, which can be detected as a function of the amplitude and frequency of the movements of the animal.

A third sub-criterion SC3 is the presence of panting detectable by analyzing the amplitude and frequency of the movements of the animal.

A fourth sub-criterion SC4 is the performing of detectable back-and-forth by analyzing the distance traveled by the animal, the amplitude and the frequency of the movements of the animal.

A fifth sub-criterion SC5 is the presence of a corresponding hyperactivity, for example, at a rest time to activity time ratio below a predetermined threshold.

A sixth sub-criterion SC6 corresponds to property destruction which can be detected by studying the amplitude and frequency of the movements of the animal.

A seventh sub-criterion SC7 is the presence of cries and/or screams by the animal (meowing or barking in particular) exceeding a predetermined sound intensity.

Any linear combination of these sub-criteria SC1 to SC7 can be envisaged, including combinations excluding some of these sub-criteria.

It is also conceivable to add other sub-criteria as a function of other symptoms to be detected.

It can also be envisaged that the preceding sub-criteria use a different test to detect the presence of the symptom.

Environment-related sub-criteria can also be considered. For example, if the microphone 28 detects a fire engine siren noise, this could be taken into account in evaluating the first criterion C1.

In any case, compliance with the first criterion C1 involves detecting a stressful event for the animal for which the application of a one-time treatment is desirable.

The switching from the secondary operating mode MS to a main operating mode MP1, MP2 or MP3 is managed by a second criterion C2 and a third criterion C3.

The second criterion C2 is used if before switching to the secondary operating mode MS the operating mode was the first main operating mode MP1.

The second criterion C2 relies on the count of the number of selections of the secondary operating mode MS during a counting duration.

As an example, if the number of selections of the secondary operating mode MS is equal to 3 over a day, the second criterion C2 is considered to be met.

When the second criterion C2 is not met, the determination unit 32 determines that it should be switched to the first main operating mode MP1.

On the other hand, when the second criterion C2 is met, the determination unit 32 determines that it should be switched to the second main operating mode MP2.

According to the example described, each predetermined duration associated with a main operating mode MP1, MP2 or MP3 and the counting duration are identical, for example equal to 1 day.

The third criterion C3 is used if before switching to the secondary operating mode MS the operating mode was the first main operating mode MP2.

Thus, when the third criterion C3 is not met, the determination unit 32 determines that it should be switched to the second main operating mode MP2 and vice versa, when the third criterion C3 is met, the determination unit 32 determines that it should switch to the third main operating mode MP3.

In the present example, the second criterion C2 and the third criterion C3 are identical.

However, different criteria may be envisaged, and in particular that the number of selections of the third criterion C3 is strictly greater than the number of selections of the second criterion C2 insofar as the third criterion C3 leads to switching to a main operating mode MP3 corresponding to a heavy treatment.

The switching between two main operating modes MP1, MP2 or MP3 is managed by a fourth criterion C4 and a fifth criterion C5.

In this case, the fourth criterion C4 makes it possible to switch from the second main operating mode MP2 to the first main operating mode MP1 while the fifth criterion C5 makes it possible to switch from the third main operating mode MP3 to the second main operating mode MP2.

In this case, the two criteria C4 and C5 are identical.

The fourth and fifth criteria C4 and C5 also rely on the number of selections of the secondary operating mode MS during a counting duration.

In this case, when the number of selections of the secondary operating mode MS is zero over a day, there is a switchover to the operating mode corresponding to a less significant treatment.

The threshold of the selection of the secondary operating mode MS may vary depending on the case but will be in any case lower than the corresponding thresholds used for the second and third criteria C2 and C3.

It may also be noted that it is prohibited from switching from the first main operating mode MP1 to the third main operating mode MP3 and vice versa.

On initialization, the control device initializes the control law to a main operating mode MP1, MP2 or MP3 as a function of second data.

The second data are information relating to the animal.

For example, a questionnaire is provided to a user, who fills it on the terminal 40. The main operating mode MP1, MP2 or MP3 is chosen according to the responses to these questions.

The questions may relate to the presence of symptoms, life habits, or the existence of recent potentially traumatic events.

For example, if the animal has recurring digestion problems, or if it cries out a lot due to symptoms.

Regarding life habits, the user will be able to indicate whether the animal is often alone or not, the type of diet of the animal.

For recent potentially traumatic events, a free field may be considered, or the user may be asked if they have recently moved.

It could also be envisaged to request the breed or age of the animal to better determine the appropriate operating mode for the animal.

Such a control system 12 makes it possible to generate a control law adapted to the behavior of the animal.

In fact, the control system 12 makes it possible to better detect the state of the animal since the state is detected continuously as soon as the animal is wearing the accessory 10.

Furthermore, the control system 12 is capable of determining how to best soothe the animal in real time and control the spraying device to apply the treatment.

Other embodiments benefit from the same advantages.

In particular, the set 16 of sensors may differ.

It will first be understood that a single sensor may be sufficient to determine the state of the animal if it is desirable. As an example, the set 16 of sensors could be limited to an accelerometer.

Furthermore, other sensors can be used alternatively or additionally.

For example, a frequency meter, a tensiometer, a global positioning system (GPS), or a body temperature sensor may be envisaged.

These various sensors share in common the ability to acquire measurements relating to the animal wearing the accessory 10 or to its environment.

According to another example, the data received by the receiving unit 30 comprises an item of third data relating to a manual activation of a button, the control law unit then selecting a secondary operating mode MS as a function of the item of third data.

The button can be an area of a touch screen or a physical button.

This allows the user to adapt the treatment if they see fit.

Alternatively or additionally, the determination unit 32 can operate according to a control law different from that which has just been described. In particular, it is possible to envisage any combination of main MPi and secondary MSj operating modes associated with each other by criteria Ck, where i, j and k are integers greater than or equal to 1 which have no presumed reason to be identical.

According to a particular embodiment, the determination unit 32 is able to learn the control law.

The determination unit 32 may in particular comprise the characteristics of the main MPi and secondary MSj operating modes, their number as well as the criteria Ck.

For this, the determination unit 32 implements a machine learning technique.

As examples, a neural network, a random forest technique, a support vector machine (SVM) technique, or Bayesian techniques can be envisaged.

The determination unit 32 could, for example, perform a temporal analysis of the behavior of the dog and/or identify points in common between the switchovers to a secondary operating mode MS.

For example, certain times of the day may be high-risk moments for which a switchover to a secondary operating mode MS is indicated.

Typically, the daily departure of the pet owner to go to work is an event occurring in a generally known time interval and for which, as a preventive, it may be indicated to switch to a secondary operating mode MS.

The control system 12 can also control the implementation of other actions.

For example, the accessory 10 could comprise the use of a loudspeaker able to broadcast messages.

In such a case, the control system 12 could command the loudspeaker to broadcast a prerecorded message to the animal in the event of stress. The prerecorded message would be, for example, a set of comforting words from the pet owner.

It could even be envisaged that if the pre-recorded message or messages do not make it possible to calm the animal, an alert is sent to the owner to perform an action, such as to speak to the animal.

In each of the embodiments, the control system 12 makes it possible to better detect the state of an animal and analyze its behavior and to determine how to best soothes the animal in real time.

Thus, a control system 12 that makes it possible to render the accessory 10 intelligent because the use of the control system 12, the set 16 of at least one sensor and the spraying device 14 renders the accessory 10 capable of implementing a method for soothing a stressed animal or treating anxiety for the animal.

The present invention relates to a system 12 for controlling an accessory 10 for animals,
the accessory 10 comprising:
a rechargeable device for spraying 14 an active ingredient comprising an active ingredient reservoir 18 and a nebulization body 20 with a controllable spray mechanism 22,
a set 16 of at least one sensor, the set 16 of at least one sensor being able to acquire measurements relating to the animal carrying the accessory 10 or to its environment, said control system 12 comprising:
a receiving unit 30 able to receive data, said data received by the receiving unit 30 comprising first data acquired by the set 16 of at least one sensor,
a determination unit 32 able to determine a control law of the spray mechanism 22 as a function of the received data, to obtain a determined control law 32, the determination unit being able to determine the control law by selecting an operating mode (MP1, MP2, MP3, MS) from a plurality of operating modes (MP1, MP2, MP3, MS), each operating mode (MP1, MP2, MP3, MS) being a control law encoding for a number of activations of the spray mechanism (22) for a predetermined duration and a duration for each activation, the number of activations and the duration of each activation being specific to each operating mode (MP1, MP2, MP3, MS),
the operating modes (MP1, MP2, MP3) comprise main operating modes (MP1, MP2, MP3), for example greater than or equal to 3, and at least one secondary operating mode (MS), a main operating mode (MP1, MP2, MP3) being an operating mode for which the predetermined duration is greater than 100 times the duration of activation and a secondary operating mode (MS) being an operating mode for which the predetermined duration is less than 5 times the duration of an activation, and
a sending unit 34 able to send the determined control law to the spray mechanism 22.

The present invention also relates to an animal accessory 10 comprising:
a rechargeable device for spraying 14 an active ingredient comprising an active ingredient reservoir 18 and a nebulization body 20 with a controllable spray mechanism 22,
a set 16 of at least one sensor, the set 16 of at least one sensor being able to acquire measurements relating to the animal carrying the accessory 10 or to its environment, and
a control system 12 as described above.

Finally, the invention describes a method for controlling an animal accessory 10 comprising:
a rechargeable device for spraying 14 an active ingredient comprising an active ingredient reservoir 18 and a nebulization body 20 with a controllable spray mechanism 22,
a set 16 of at least one sensor, the set 16 of at least one sensor being able to acquire measurements relating to the animal carrying the accessory 10 or to its environment, the control method being performed by a control system 12 and comprising the steps of:
receiving the data, the received data comprising first data, the first data being data acquired by the set 16 of at least one sensor,
determining a control law of the spray mechanism 22 as a function of the received data, to obtain a determined control law, the step of determining comprising selecting an operating mode (MP1, MP2, MP3, MS) from a plurality of operating modes (MP1, MP2, MP3, MS), each operating mode (MP1, MP2, MP3, MS) being a control law encoding for a number of activations of the spray mechanism (22) for a predetermined duration and a duration for each activation, the number of activations and the duration of each activation being specific to each operating mode (MP1, MP2, MP3, MS),
the operating modes (MP1, MP2, MP3) comprise main operating modes (MP1, MP2, MP3), for example greater than or equal to 3, and at least one secondary operating mode (MS), a main operating mode (MP1, MP2, MP3) being an operating mode for which the predetermined duration is greater than 100 times the duration of activation and a secondary operating mode (MS) being an operating mode for which the predetermined duration is less than 5 times the duration of an activation, and
sending the determined control law to the spray mechanism 22.

1. A system (12) for controlling an animal accessory (10), the accessory (10) comprising:
a rechargeable device for spraying (14) an active ingredient comprising an active ingredient reservoir (18) and a nebulization body (20) with a controllable spray mechanism (22),
a set (16) of at least one sensor, the set (16) of at least one sensor being able to acquire measurements relating to the animal carrying the accessory (10) or to its environment,
said control system (12) comprising:
a receiving unit (30) able to receive data, said data received by the receiving unit (30) comprising first data acquired by the set (16) of at least one sensor,
a determination unit (32) able to determine a control law of the spray mechanism (22) as a function of the received data, to obtain a determined control law (32), the determination unit being able to determine the control law by selecting an operating mode (MP1, MP2, MP3, MS) from a plurality of operating modes (MP1, MP2, MP3, MS), each operating mode (MP1, MP2, MP3, MS) being a control law encoding for a number of activations of the spray mechanism (22) for a predetermined duration and a duration for each activation, the number of activations and the duration of each activation being specific to each operating mode (MP1, MP2, MP3, MS),
the operating modes (MP1, MP2, MP3) comprise main operating modes (MP1, MP2, MP3), for example greater than or equal to 3, and at least one secondary operating mode (MS), a main operating mode (MP1, MP2, MP3) being an operating mode for which the predetermined duration is greater than 100 times the duration of activation and a secondary operating mode (MS) being an operating mode for which the predetermined duration is less than 5 times the duration of an activation, and
a sending unit (34) able to send the determined control law to the spray mechanism (22).

2. The control system according to claim 1, wherein the set (16) of sensors comprises a motion measurement unit (26) comprising at least one of an accelerometer or a gyroscope, the first data comprising a property of a motion of the animal, the property being selected from the amplitude of the motion of the animal, the frequency of the motion of the animal, the distance made by the animal, the direction of the motion of the animal or the duration of the motion of the animal.

3. The control system according to claim 1 or 2, wherein the set (16) of the sensors comprises a microphone (28), the first data comprising a property of a sound recorded by the microphone (28), the property being chosen from the sound intensity of the sound, the sound frequency of the sound or the duration of the sound.

4. The control system according to any one of claims 1 to 3, wherein the determination unit (32) is able to determine whether a criterion relating to the first data is satisfied and is able to select a secondary operating mode (MS) when said criterion is satisfied.

5. The control system according to any of claims 1 to 4, wherein the determination unit (32) is able to count the number of selections of a secondary operating mode (MS) during a counting duration, the determination unit (32) switching from a main operating mode (MP1, MP2, MP3) to another main operating mode (MP1, MP2, MP3) as a function of the number of selections counted.

6. The control system according to claim 5, wherein each predetermined duration associated with a main operating mode (MP1, MP2, MP3) and the counting duration are identical.

7. The control system according to any one of claims 1 to 6, wherein the data received by the receiving unit (30) comprises second data, the second data being information relating to the animal, the determination unit (32) being able to initialize the control law to a main operating mode (MP1, MP2, MP3) selected according to the second data.

8. The control system according to any one of claims 1 to 7, wherein the data received by the receiving unit (30) comprises an item of third data relating to a manual activation of a button, the determination unit (32) then selecting a secondary operating mode (MS) as a function of the item of third data.

9. An animal accessory (10) comprising:
a rechargeable device for spraying (14) an active ingredient comprising an active ingredient reservoir (18) and a nebulization body (20) with a controllable spray mechanism (22),
a set (16) of at least one sensor, the set (16) of at least one sensor being able to acquire measurements relating to the animal carrying the accessory (10) or to its environment, and
a control system (12) according to any of claims 1 to 8.
